(19) United States
(12) Patent Application Publication
(10) Pub. No.: US 2023/0294036 A1
(43) Pub. Date: Sep. 21, 2023

(54) FAST CHARGING STATION WITH INTEGRATED CO2-COLLECTOR

(71) Applicant: AUDI AG, Ingolstadt (DE)

(72) Inventor: Ralph HOLLMIG, Ingolstadt (DE)

(21) Appl. No.: 18/184,575

(22) Filed: Mar. 15, 2023

(30) Foreign Application Priority Data
Mar. 17, 2022 (DE) 10 2022 106 293.7

(51) Int. Cl. B01D 53/04; H02J 7/34; B60L 53/302

(52) U.S. Cl. CPC B01D 53/0438; B01D 53/0446; B60L 53/302; H02J 7/342; B01D 2257/504; B01D 2259/40098

(57) ABSTRACT

A method is provided for a combination of CO₂-capture and storage from the ambient air and fast charging of electric vehicles. A charging station for electric vehicles is also provided.

### BACKGROUND

### Technical Field

The present disclosure relates to a combination of CO₂-capture from the ambient air and fast charging of electric vehicles.

### Description of the Related Art

The capture of carbon dioxide from the ambient air is finding increased interest as a way of reducing the greenhouse effect caused by the carbon dioxide content of the atmosphere. The known methods for separation of carbon dioxide from atmospheric air usually require a substantial energy expenditure.

DE 10 2020 122 123 A1 relates to a vehicle with a rechargeable battery, a charging port connected to an external power source by a charging cable for supplying electric energy to the battery, a CO₂-recovery device for recovering of CO₂ from the ambient air, a CO₂-collection port connected to a collection hose for the collection of CO₂ from the CO₂-recovery device, and a single opening lid covering both the charging port and the CO₂-collection port. The battery can be charged at a service station and the collected CO₂ can be transferred from the CO₂-recovery device of the vehicle.

WO 2010 / 059 804 A2 relates to a method for recovery of CO₂ from a fluid stream and a CO₂ monitoring device comprising a flow device and a CO₂-absorbing filter treated with an alkaline material, situated in the flow device. The flow device receives a fluid stream and the CO₂ is absorbed from the fluid stream by the CO₂-absorbing filter. The absorbed CO₂ is converted into CaCO₃, which is combined with volcanic ash in order to form a useful cement material.

### BRIEF SUMMARY

The present disclosure provides a method and a device with which the energy balance of CO₂-capture from ambient air can be improved.

In some embodiments, the capture of carbon dioxide from the ambient air is done by utilizing the waste heat generated during the fast charging of electric vehicles.

Some embodiments include a method for capture and storage of carbon dioxide from the ambient air, during which in a first step ambient air is taken through a filter which adsorbs carbon dioxide, and in a second step the filter is heated in order to release the adsorbed carbon dioxide, wherein the waste heat produced during the fast charging of at least one electric vehicle at least at one fast charging point is utilized for the heating of the filter.

In the first step of the method, ambient air flows through a filter, which binds a portion of the carbon dioxide and removes it from the ambient air. In one embodiment, the filter comprises cellulose and nitrogen compounds which bind carbon dioxide. In a second step, for example when the adsorption capacity of the filter is exhausted, the filter is heated in order to release the bound carbon dioxide once again.

In one embodiment of the method, in the first step an air flow is created by at least one blower fan or at least one fan and taken through the filter. In another embodiment, the electric energy for operating the at least one blower fan or at least one fan is provided from a buffer battery of the fast charging point.

In one embodiment of the method, the filter is heated to a temperature in the range of 60 to 150° C., for example 100° C., for the releasing of adsorbed carbon dioxide.

For the heating of the filter, the waste heat produced during the fast charging process of the electric vehicles is utilized. Fast charging creates large amounts of waste heat in high voltage (HV) batteries. At 350 kW charging power, up to 37 kW of waste heat is produced, which can be utilized for heating of the filter.

The waste heat is removed from the HV batteries of the electric vehicles and transferred to the charging station, where it can be used for heating the filter and its regeneration.

In one embodiment of the method, the filter is additionally subjected to reduced pressure for the releasing of adsorbed carbon dioxide. Under reduced pressure the carbon dioxide bound in the filter is more easily released.

Thanks to the heating of the filter, optionally under reduced pressure, very pure CO₂ is obtained. In one embodiment of the method, the carbon dioxide released in the second step is stored in a collection tank. The carbon dioxide stored in the collection tank is available for further use. For example, it can be used for the production of beverages containing carbonic acid or for accelerating plant growth.

Some embodiments include a charging station for electric vehicles. The charging station comprises at least one fast charging point for electric vehicles and at least one module for capture and storage of carbon dioxide from the ambient air, wherein the module can be heated by the waste heat produced during the fast charging of electric vehicles at the at least one fast charging point.

In one embodiment of the charging station, the at least one module for capture and storage of carbon dioxide from the ambient air contains a filter, which is adapted to adsorb carbon dioxide from the ambient air and to release it once more upon heating to a temperature in the range of 60 to 150° C., optionally under reduced pressure.

In one embodiment of the charging station, the at least one module for capture and storage of carbon dioxide from the ambient air has a gas inlet and a gas outlet, as well as at least one fan and/or a blower for creating an air flow through the module, and a device for creating a partial vacuum in the module.

In one embodiment of the charging station, the at least one module for capture and storage of carbon dioxide from the ambient air is connected to a collection tank for receiving and storing of CO₂.

In one embodiment, the charging station comprises a roof on which is arranged the at least one module for capture and storage of carbon dioxide from the ambient air, and beneath which are arranged the at least one fast charging point, at least one buffer battery, at least one unit for control of the at least one fast charging point and the at least one module for capture and storage of carbon dioxide from the ambient air, and at least one collection tank for receiving and storing of CO₂.

The carbon dioxide capture is thus integrated on the roof of the charging station. Blowers and/or fans of the at least one module are operated through the buffer battery.

In one embodiment, the charging station comprises devices which are adapted to take away the waste heat produced during the first charging from the HV batteries of the electric vehicles and transfer it to the charging station, as well as devices with which the transferred waste heat can be used for heating the filter and its regeneration.

In one embodiment, the waste heat is taken away by cooled charging cables of the HV battery of the electric vehicle and transferred to the charging station.

In another embodiment in which the electric vehicle has a heat exchanger integrated in or on the HV battery, which can be connected by ports on the charging socket of the electric vehicle to a cooling circuit of the charging station, the waste heat is taken away by the cooling circuit of the charging station from the HV battery of the electric vehicle and transferred to the charging station.

In a further embodiment, the transferred waste heat is transferred by a heat exchanger of the charging station to a heat storage of the charging station and stored there temporarily. The heat storage in one embodiment is likewise arranged beneath the roof of the charging station. The temporarily stored heat can then be used via a heating circuit for the heating of the filter. In one variant, the transferred waste heat is utilized directly for the heating of the filter without a temporary storage.

In some embodiments, waste heat produced during the fast charging of vehicles can be used sensibly and the roof surfaces of charging stations can be given an added utility. Finally, the concept makes a contribution to improving the energy balance of carbon dioxide separation from the atmosphere.

Of course, the features mentioned above and those yet to be explained below can be used not only in the particular indicated combination, but also in other combinations or standing alone. Put another way, aspects of the various embodiments described herein can be combined to provide further embodiments.

### BRIEF DESCRIPTION OF THE SEVERAL VIEWS OF THE DRAWINGS

FIG. 1 shows a schematic representation of a module for CO₂-capture from the ambient air.

### DETAILED DESCRIPTION

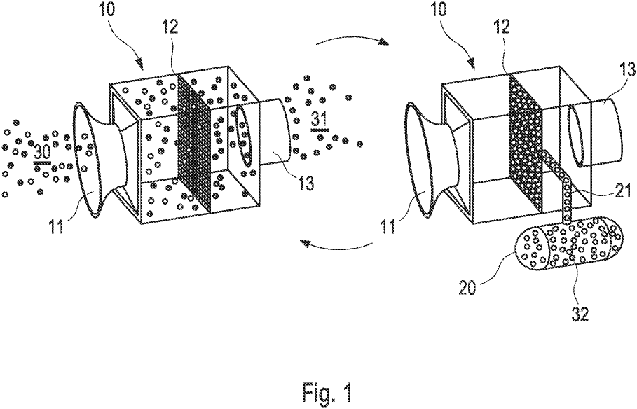

FIG. 1 shows schematically a module 10 for the capture of CO₂ 32 from ambient air 30 and the manner of its working. The module 10 has a gas inlet 11, through which ambient air 30 can be sucked in and taken inside the module 10, where a filter 12 is located, which chemically binds CO₂ 32. Through a gas outlet 13, air 31 depleted in CO₂ 32 is taken out from the module 10. Additional components not shown in the drawing are found in the module 10: a fan or a blower for creating an air flow through the module 10, a device or means of heating the filter 12 and a device or means of generating a partial vacuum in the module 10. A collection tank 20 for receiving of concentrated CO₂ 32 is connected by a pipeline 21 to the module 10.

The working cycle of the module 10 comprises two phases which are performed in alternation. At the left side of the drawing, the module 10 is shown in the first phase of the working cycle. Ambient air 30 is sucked in through the gas inlet 11 and taken through the module 10, the filter 12 adsorbs CO₂ 32 from the ambient air 30 and air 31 depleted in CO₂ 32 is taken through the gas outlet 13 from the module 10. At the right side of the drawing, the module 10 is shown in the second phase of the working cycle. The filter 12 is heated and releases adsorbed CO₂ 32, which is taken by the pipeline 21 to the collection tank 20 where it is stored.

German patent application no. 10 2022 106293.7, filed Mar. 17, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for capture and storage of carbon dioxide from the ambient air, the method comprising:
taking ambient air through a filter which adsorbs carbon dioxide; and
heating the filter in order to release the adsorbed carbon dioxide, wherein waste heat produced during fast charging of at least one electric vehicle at least at one fast charging point is utilized for the heating of the filter.

2. The method according to claim 1, wherein the filter is heated to a temperature in the range of 60 to 150° C. for the releasing of adsorbed carbon dioxide.

3. The method according to claim 1, wherein the filter is subjected to reduced pressure for the releasing of adsorbed carbon dioxide.

4. The method according to claim 1, wherein the carbon dioxide is stored in a collection tank.

5. The method according to claim 1, wherein taking the ambient air through the filter includes creating an air current by at least one blower fan or at least one fan and taken through the filter, and wherein the electric energy for operating the at least one blower or the at least one fan is provided by a buffer battery of the fast charging point.

6. A charging station for electric vehicles, comprising:
at least one fast charging point for electric vehicles; and
at least one module for capture and storage of carbon dioxide from the ambient air, wherein the module can be heated by the waste heat produced during the fast charging of at least one electric vehicle at the at least one fast charging point.

7. The charging station according to claim 6, wherein the at least one module for capture and storage of carbon dioxide from the ambient air contains a filter, which is adapted to adsorb carbon dioxide from the ambient air and to release it once more upon heating to a temperature in the range of 60 to 150° C.

8. The charging station according to claim 6, wherein the at least one module for capture and storage of carbon dioxide from the ambient air has a gas inlet and a gas outlet, at least one fan and/or a blower for creating an air flow through the module, and a vacuum device for creating a partial vacuum in the module.

9. The charging station according to claim 6, wherein the at least one module for capture and storage of carbon dioxide from the ambient air is connected to a collection tank for receiving and storing of CO₂.

10. The charging station according to claim 6, further comprising a roof on which is arranged the at least one module for capture and storage of carbon dioxide from the ambient air, and beneath which are arranged the at least one fast charging point, at least one buffer battery, at least one unit for control of the at least one fast charging point and the at least one module for capture and storage of carbon dioxide from the ambient air, and at least one collection tank for receiving and storing of CO₂.
